(19) United States
(12) Patent Application Publication
(10) Pub. No.: US 2025/0246346 A1
(43) Pub. Date: Jul. 31, 2025

(54) Method of sintering solderable base metals in air atmosphere and manufacturing alloy components

(71) Applicant: National Cheng Kung University, Tainan (TW)

(72) Inventor: Wen-Hsi Lee, Tainan (TW)

(21) Appl. No.: 18/424,078

(22) Filed: Jan. 26, 2024

(51) Int. Cl. H01C 7/00; B22F 1/00; B22F 1/10; B22F 3/10; C23C 24/08; H01C 1/14; H01C 17/065; H01C 17/22; H01G 4/30

(52) U.S. Cl. CPC H01C 7/003; B22F 1/09; B22F 1/10; B22F 3/1007; C23C 24/087; H01C 1/1406; H01C 1/1413; H01C 17/065; H01C 17/22; B22F 2201/50; B22F 2301/052; B22F 2301/10; B22F 2301/30; B22F 2998/10; H01G 4/30

(57) ABSTRACT

A method of sintering solderable base metals in air atmosphere and manufacturing alloy components to manufacture solderable electrodes by heat treatment instead of electroplating processes. The method involves introducing into an electrode plenty of metallic tin powder directly, then metallic aluminum powder with high-oxidation enthalpy formation to protect tin against oxidation, and other metals, say metallic copper powder, to produce copper-tin alloy to increase the melting point of the electrode. With the method, tin, as a base, directly functions as an electrode, covering the tin electrode with aluminum film to protect the tin electrode against oxidation during heat treatment, introducing appropriate metals, say copper, into the tin film to produce alloy from tin and copper to increase the melting point of the electrode. With electroplating processes replaced by heat treatment, electronic components, i.e., electrodes, are manufactured without any tin electroplating process but exhibit high solderability and excellent functionality.

### TECHNICAL FIELD OF THE INVENTION

The present disclosure relates to a method of sintering solderable base metals in air atmosphere and manufacturing alloy components, and more particularly to a method of manufacturing, by heat treatment process instead of electroplating processes, electronic component electrodes which undergo no tin electroplating process but become solderable electrodes characterized by high solderability and excellent functionality.

### DESCRIPTION OF THE RELATED ARTS

Prior art 1: although thick-film printed precious metal silver or silver palladium alloy may undergo high-temperature heat treatment in air atmosphere, precious metal and alloy are expensive.
Prior art 2: although thick-film printed base metal copper, nickel or copper nickel alloy may replace precious metal silver or silver palladium alloy, heat treatment has to occur in reduction atmosphere so as to preclude the base metal copper, nickel or copper nickel alloy from undergoing oxidation and incurring the resultant loss of its functions; although replacing the precious metal with the base metal is conducive to cost reduction, the heat treatment process has to be carried out with reduction atmosphere sintering instead of air atmosphere sintering and thus increase the process cost greatly.
Prior art 3: existing electronic components can be soldered to circuit boards only in the presence of electroplated tin, regardless of whether the existing electronic components use the precious metal sintered in air atmosphere and disclosed in prior art 1 or the base metals sintered in reduction atmosphere and disclosed in prior art 2 as the electrodes.

As a result, the fundamental cause of the drawbacks of the prior art is that existing electronic components have to undergo an electrode manufacturing process with a view to achieving three functions as follows:
Function 1: connect electronic components to render the electronic components electrically connected.
Function 2: connect electronic components tightly with high mechanical strength.
Function 3: enable an electronic component to be coupled to an electronic circuit board by tin solder.

Therefore, every existing electronic component has to undergo a tin electroplating process to electroplate the electrode surface with a tin layer to acquire solderability in order for the electronic component to be coupled to an electronic circuit board by tin soldering paste, regardless of whether the electronic component uses a precious metal electrode sintered in air atmosphere or a base metal electrode sintered in reduction atmosphere. However, electroplating is a process which causes severe pollution to the environment. Therefore, it is necessary to devise a way of enabling a metal electrode to acquire solderability without undergoing an additional step of electroplating a tin layer.

The tin soldering paste essentially comprises a flux and tin powder which are fully mixed. Although the tin soldering paste is cheap and has satisfactory electrical conductivity, the tin soldering paste undergoing heat treatment is predisposed to oxidation and agglomeration. As a result, the tin soldering paste cannot be used to make electrodes but can only be used as tin solder for connecting an electronic component to a silver electrode or copper electrode.

The degree of solderability of the tin soldering paste depends on the size of the tin soldering paste particles. Given equal quality, the smaller its particles are, the greater is tin soldering paste's viscosity, wettability, rate of dissolving, and thus applicability to fine-particle, high-precision products. However, the tin soldering paste with smaller particles is more likely to be oxidized and more expensive. As a result, the prior art fails to meet the need for solderable electrodes whose manufacturing processes dispense with an electroplating process.

### SUMMARY OF THE INVENTION

It is an objective of the disclosure to overcome the aforesaid drawbacks of the prior art and provide a method of manufacturing, by heat treatment process instead of electroplating processes, electronic component electrodes which undergo no tin electroplating process but become solderable electrodes characterized by high solderability and excellent functionality.

To achieve the above and other objectives, the disclosure provides a method of sintering solderable base metals in air atmosphere and manufacturing alloy components, comprising the steps of: introducing 10˜90 wt % of metallic aluminum powder into printed thick-film base metal tin conductive paste film or base metal tin alloy conductive paste film or printing thick-film base metal tin conductive paste film or base metal tin alloy conductive paste film and then printing thereon thick-film aluminum protection layer; and performing heat treatment at 300˜600° C. in air atmosphere, wherein high oxyphilic characteristics of the metallic aluminum powder or the aluminum protection layer protect the base metal tin conductive paste film or base metal tin alloy conductive paste film against oxidation during high-temperature sintering in air atmosphere, wherein, after the base metal tin conductive paste film or base metal tin alloy conductive paste film has undergone high-temperature sintering and oxidation in air atmosphere, the oxidized base metal tin conductive paste film or base metal tin alloy conductive paste film is reduced to metal and alloy because of strong reduction characteristics of the metallic aluminum powder or the aluminum protection layer to obtain a thick-film base metal tin electrode or base metal tin alloy electrode having high solderability and a high melting point.

In the embodiment of the disclosure, the base metal tin alloy conductive paste film is any one of tin copper alloy and tin nickel alloy.

In the embodiment of the disclosure, the aluminum protection layer is any one of aluminum film, aluminum alloy film, and aluminum oxide film.

In the embodiment of the disclosure, the aluminum alloy film is copper aluminum alloy, the aluminum oxide film is copper oxide.

To achieve the above and other objectives, the disclosure further provides a block-shaped ceramic component, comprising two outer terminal electrodes each being the sintered thick-film base metal tin outer terminal electrode or base metal tin alloy outer terminal electrode formed by the method.

In the embodiment of the disclosure, the block-shaped ceramic component ceramic antenna, is GPS (NTC) thermistor, negative-temperature-coefficient positive-temperature-coefficient (PTC) thermistor, voltage-dependent resistor (VDR), or safety capacitor.

To achieve the above and other objectives, the disclosure further provides a multilayer ceramic component, comprising an outer terminal electrode being the sintered thick-film base metal tin outer terminal electrode or base metal tin alloy outer terminal electrode formed by the method.

In the embodiment of the disclosure, the multilayer ceramic component is low temperature co-fired ceramic (LTCC), multilayer ceramic capacitor (MLCC), multilayer NTC component, or multilayer VDR component.

In the embodiment of the disclosure, a multilayer co-fired ceramic component undergoes high-temperature sintering, then nickel electroplating, next base metal tin conductive paste film dipping or base metal tin alloy conductive paste film dipping, then aluminum protection layer dipping, and finally heat treatment and sintering in air atmosphere for removal of the aluminum protection layer so as to form the outer terminal electrode.

In the embodiment of the disclosure, a multilayer co-fired ceramic component undergoes high-temperature sintering, then base metal tin conductive paste film dipping or base metal tin alloy conductive paste film dipping, next aluminum protection layer dipping, and finally heat treatment and sintering in air atmosphere for removal of the aluminum protection layer so as to form the outer terminal electrode.

To achieve the above and other objectives, the disclosure further provides a chip resistor, comprising a front electrode or a rear electrode connected to a resistance layer, the front electrode being the sintered thick-film base metal front tin electrode, base metal front tin alloy electrode, base metal rear tin electrode or base metal rear tin alloy electrode formed by the method, and the rear electrode being the sintered thick-film base metal front tin electrode, base metal front tin alloy electrode, base metal rear tin electrode or base metal rear tin alloy electrode formed by the method.

To achieve the above and other objectives, the disclosure further provides a method of manufacturing a chip alloy resistor comprising a base metal functioning as an alloy resistance layer, comprising the steps of: printing thick-film base metal alloy resistive paste film; printing thereon a thick-film aluminum protection layer; and performing heat treatment at 500˜1400° C. in air atmosphere by a chip resistance process, wherein high oxyphilic characteristics of the aluminum protection layer protect the base metal alloy resistive paste film against oxidation during high-temperature sintering in air atmosphere to allow the aluminum protection layer to be capable of achieving insulation but functioning as a heat dissipating layer with high thermal conductivity so as to obtain a thick-film base metal alloy resistance layer having high solderability and resistance characteristics.

In the embodiment of the disclosure, the base metal alloy resistive paste film is any one of copper nickel film, copper manganese film, and nickel chromium (silicon) film.

In the embodiment of the disclosure, the aluminum protection layer is any one of aluminum film, aluminum alloy film, and aluminum oxide film.

In the embodiment of the disclosure, the aluminum alloy film is copper aluminum alloy, and the aluminum oxide film is copper oxide.

In the embodiment of the disclosure, upon completion of folding in the chip resistance process, a side-conduction process is performed to sputter high electrical conductivity metal tin for connection with the base metal alloy resistance layer inside to form an Ohmic contact, and then subsequent standard processes are performed by the chip resistance process to form the chip alloy resistor.

### BRIEF DESCRIPTION OF THE DRAWINGS

FIG. 1 shows images of fine structures of aluminum enriched with tin and sintered according to the disclosure.

FIG. 2 shows images of fine structures of aluminum enriched with copper-tin and sintered according to the disclosure.

FIG. 3 shows images of fine structures of aluminum film covered with tin copper film and sintered according to the disclosure.

FIG. 4 shows images of fine structures of ceramic component aluminum copper-tin outer electrodes manufactured by a novel process according to the disclosure.

FIG. 5 shows images of fine structures of ceramic component tin outer electrodes manufactured by the novel process according to the disclosure.

FIG. 6 is a schematic view of how to sinter a tin outer electrode with a multilayer ceramic component by the novel process according to the disclosure.

FIG. 7 is a schematic view of how to sinter a tin outer electrode directly with a multilayer ceramic component by the novel process according to the disclosure.

FIG. 8 is a schematic view of chip resistor front tin and rear tin electrodes according to the disclosure.

FIG. 9 shows images of fine structures of a protection layer for use in sintering an alloy resistor in air atmosphere according to the disclosure.

FIG. 10 is a schematic view of a side-conduction process performed in sintering an alloy resistor in air atmosphere and shows images of fine structures of its electrode according to the disclosure.

### DESCRIPTION OF THE PREFERRED EMBODIMENT

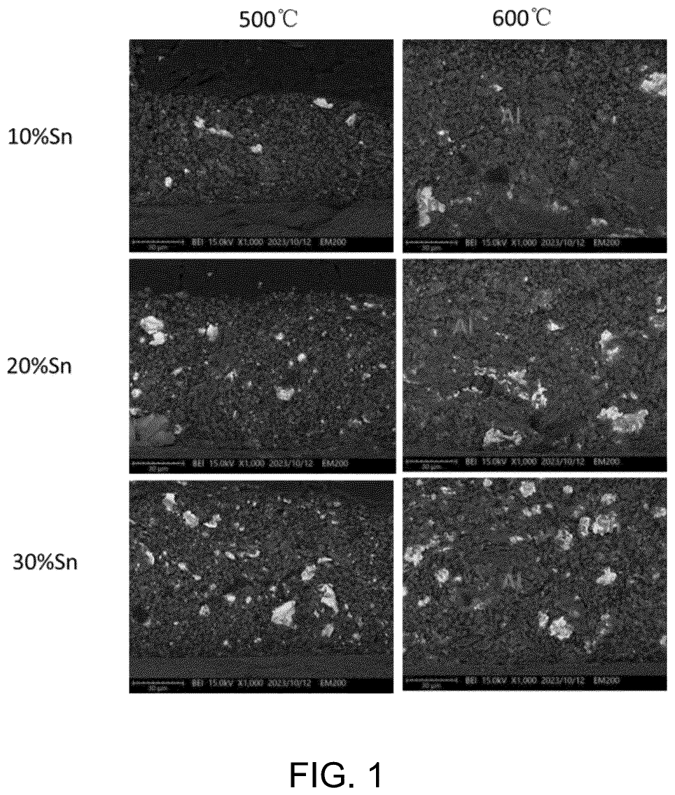

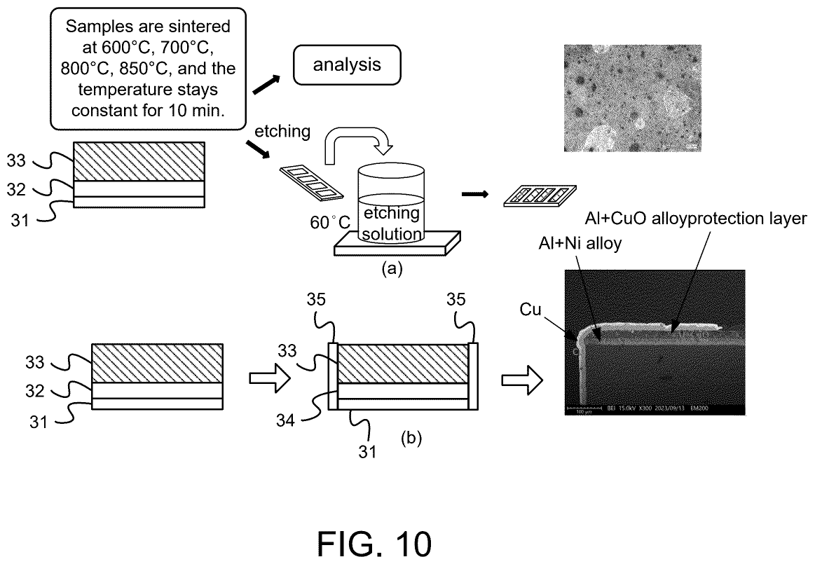

Referring to FIG. 1˜FIG. 10, there are shown images of fine structures of aluminum enriched with tin and sintered according to the disclosure, images of fine structures of aluminum enriched with copper-tin and sintered according to the disclosure, images of fine structures of aluminum film covered with tin copper film and sintered according to the disclosure, images of fine structures of ceramic component aluminum copper-tin outer electrodes manufactured by a novel process according to the disclosure, images of fine structures of ceramic component tin outer electrodes manufactured by the novel process according to the disclosure, a schematic view of how to sinter a tin outer electrode with a multilayer ceramic component by the novel process according to the disclosure, a schematic view of how to sinter a tin outer electrode directly with a multilayer ceramic component by the novel process according to the disclosure, a schematic view of chip resistor front tin and rear tin electrodes according to the disclosure, images of fine structures of a protection layer for use in sintering an alloy resistor in air atmosphere according to the disclosure, a schematic view of a side-conduction process performed in sintering an alloy resistor in air atmosphere and images of fine structures of its electrode according to the disclosure, respectively. As shown in the diagrams, the disclosure relates to a method of sintering solderable base metals in air atmosphere and manufacturing alloy components. The method involves introducing metallic aluminum powder into printed thick-film base metal tin conductive paste film or base metal tin alloy conductive paste film or printing thick-film base metal tin conductive paste film or base metal tin alloy conductive paste film and then printing thereon a thick-film aluminum protection layer, performing heat treatment at 300˜600° C. in air atmosphere, using high oxyphilic characteristics of the metallic aluminum powder or the aluminum protection layer to protect the base metal tin conductive paste film or base metal tin alloy conductive paste film against oxidation during high-temperature sintering in air atmosphere. Alternatively, after the base metal tin conductive paste film or base metal tin alloy conductive paste film has undergone high-temperature sintering and oxidation in air atmosphere, the oxidized base metal tin conductive paste film or base metal tin alloy conductive paste film is reduced to metal and alloy because of the strong reduction characteristics of the metallic aluminum powder or the aluminum protection layer, and thus the base metal tin or tin alloy which can be readily oxidized during high-temperature sintering in air atmosphere can still maintain metallic electrical conductivity or alloy characteristics, forming the thick-film base metal tin electrode or base metal tin alloy electrode which has high solderability and a high melting point.

To enable metal electrodes to exhibit solderability in practice without undergoing an additional step of electroplating a tin layer, the disclosure provides two embodiments of manufacturing solderable electrodes by heat treatment instead of electroplating processes as follows:

First, according to the disclosure, plenty of metallic tin powder is introduced into an electrode directly. However, metal electrodes must neither be oxidized nor dissolved to become liquid at a sintering temperature. To prevent metallic tin powder from being oxidized during heat treatment in air atmosphere, metallic aluminum powder with high-oxidation enthalpy formation is added to the metallic tin powder to protect tin against oxidation. Furthermore, the metallic tin powder, which has a low melting point, is enriched with any other metals, such as metallic copper powder, to produce copper-tin alloy so as to increase its melting point.

Second, according to the disclosure, tin directly functions as an electrode. The tin electrode is directly covered with aluminum film to prevent the tin electrode from being oxidized during heat treatment. Furthermore, to prevent tin from being dissolved to become liquid during heat treatment, appropriate metals, such as copper, can be introduced into tin film to produce tin copper alloy to increase the melting point of the electrode.

The embodiments serve illustrative purposes to explain the details and contents of the disclosure but are not restrictive of the claims of the disclosure.

Metallic aluminum powder is added to metallic tin powder, or metal copper and tin to produce thick-film conductive paste film which then undergoes screen printing to turn into thick film that undergoes heat treatment and sintering at 300˜600° C. in air atmosphere to attain the resistance values and resistance characteristics shown in Table 1 and Table 2 below.

TABLE 1

| temperature/ | | | | | |
|---|---|---|---|---|---|
| resistance | | | | | |
| value | 550° C. | 600° C. | 650° C. | 700° C. | 750° C. |
| Sn0% | X | 192 m | 183 m | 227 m | 364 m |
| Sn10% | X | 336 m | 422 m | 350 m | 439 m |
| Sn20% | X | 457 m | 960 m | 992 m | X |

Referring to Table 1, the more metallic aluminum powder is added to metallic tin powder, the greater is the anti-oxidation capability of the metallic tin powder during heat treatment, and tin aluminum mixture conductive paste film sintered at 600° C. in air atmosphere can still maintain high electrical conductivity in the situation of adding 40 wt % of metallic aluminum powder to 60 wt % of metallic tin powder or adding 30 wt % of metallic aluminum powder to 70 wt % of metallic tin powder.

TABLE 2

| | | |
|---|---|---|
| resistance value | 600° C. | 650° C. |

| | | | | |
|---|---|---|---|---|
| 3C7A-Sn10% | 103 | m | 105 | m |
| 3C7A-Sn20% | 112 | m | 136 | m |
| 3C7A-Sn30% | 169 | m | 156 | m |
| 3C7A-Sn40% | 172 | m | 220 | m |
| 4C6A-Sn10% | 103 | m | 165 | m |
| 4C6A-Sn20% | 152 | m | 236 | m |
| 4C6A-Sn30% | 269 | m | 665 | m |
| 4C6A-Sn40% | 472 | m | 1350 | m |
| 5C5A-Sn10% | 234 | m | 224 | m |
| 5C5A-Sn20% | 321 | m | 386 | m |
| 5C5A-Sn30% | 381 | m | 282 | m |
| 6C4A-Sn10% | 487 | m | 294 | m |

| | | | |
|---|---|---|---|
| 6C4A-Sn20% | 600 | m | 1.44 |
| 6C4A-Sn30% | 2600 | m | 13 |

Referring to Table 2, the more metallic aluminum powder is added to the mixture of metallic tin powder and copper powder, the greater is the anti-oxidation capability of the mixture of metallic tin powder and copper powder during heat treatment, and copper aluminum mixture conductive paste film sintered at 600° C. in air atmosphere can still maintain high electrical conductivity in the situation of adding 50 wt % of metallic aluminum powder to 50 wt % of metallic copper powder or adding 40 wt % of metallic aluminum powder to 60 wt % of metallic copper powder.

FIG. 1 shows images of fine structures of metallic aluminum powder enriched with metallic tin powder and sintered at temperature 500° C. and 600° C. in air atmosphere (observed at 1000× magnification). Owing to the presence of aluminum metal powder with high oxyphilic characteristics, tin apparently still maintains the characteristic of high electrical conductivity of metals even after being sintered at high temperature in air atmosphere.

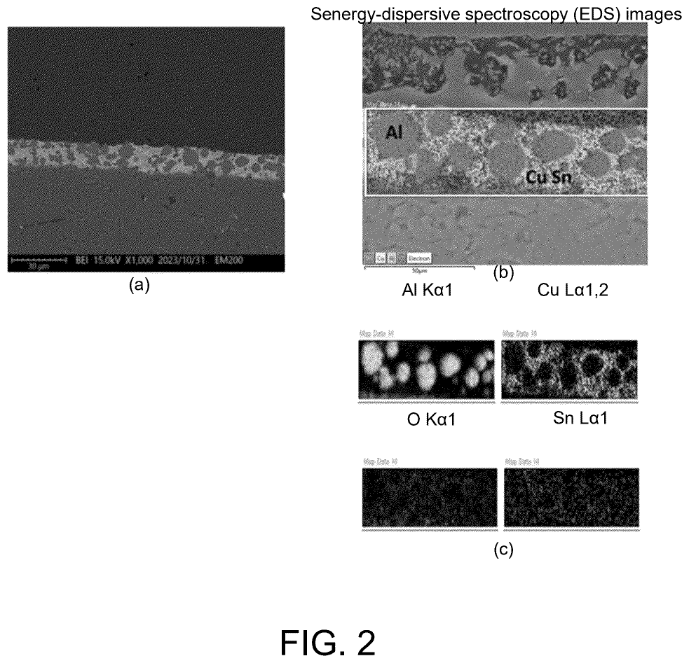

FIG. 2 shows images of fine structures of metallic aluminum powder enriched with the mixture of metallic tin powder and copper powder and sintered at different temperatures in air atmosphere. Referring to FIG. 2, Diagram (a) shows fine structures observed at 1000× magnification, Diagram (b) shows energy-dispersive spectroscopy (EDS) images, and Diagram (c) is a material analysis diagram. Owing to the presence of aluminum metal powder with high oxyphilic characteristics, tin copper alloy or tin, copper metal apparently still maintains the characteristic of high electrical conductivity of metals even after being sintered at high temperature in air atmosphere.

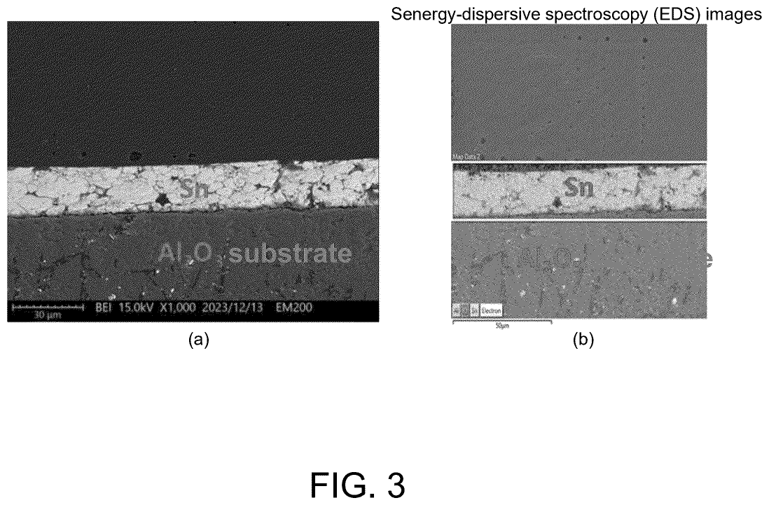

FIG. 3 shows images of fine structures formed by printing aluminum film or aluminum-related alloy (such as copper aluminum) film for covering printed metal tin film and then by performing sintering temperature 400° C. in air atmosphere. Referring to FIG. 3, Diagram (a) shows fine structures observed at 1000× magnification, and Diagram (b) shows energy-dispersive spectroscopy (EDS) images. Owing to the presence of metal aluminum film or aluminum-related alloy (such as copper aluminum) film with high oxyphilic characteristics and strong reduction characteristics, the underlying metal tin film apparently still maintains the characteristic of high electrical conductivity of metals even after being sintered at high temperature in air atmosphere.

### EMBODIMENT 1

In a preferred specific embodiment of the disclosure, the disclosure provides a novel process applicable to a block-shaped ceramic component outer electrode, and the block-shaped ceramic component is GPS ceramic antenna, negative-temperature-coefficient (NTC) thermistor, positive-temperature-coefficient (PTC) thermistor, voltage-dependent resistor (VDR), or safety capacitor.

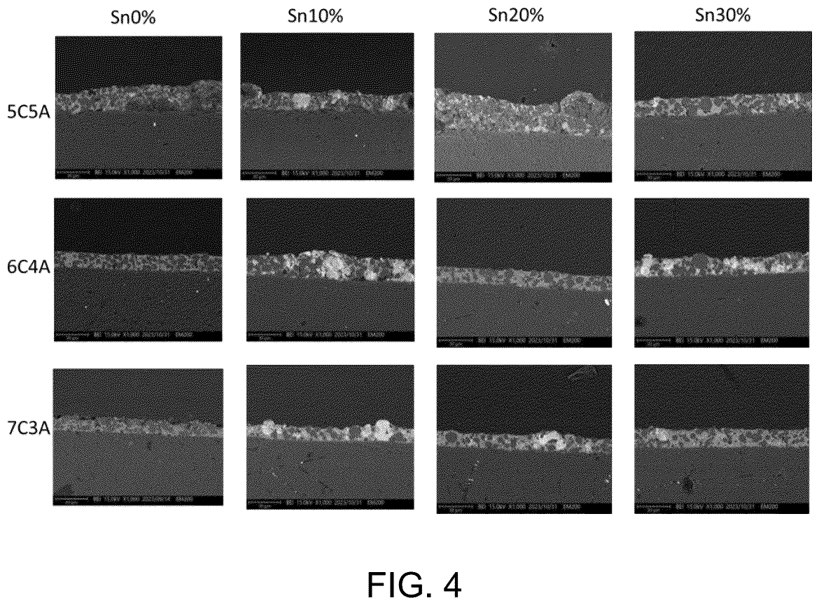

According to the disclosure, conductive paste film is manufactured with a mixture of tin, aluminum and copper and printed on two sides of the block-shaped ceramic component to function as outer terminal electrodes, and then heat treatment is performed thereon at 300˜600° C. in air atmosphere, as shown in FIG. 4.

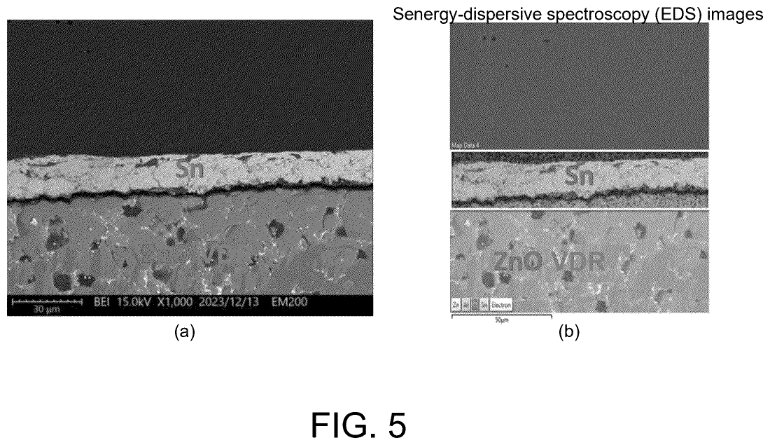

Tin electrodes are printed on two sides of the block-shaped ceramic component respectively. Then, the aluminum protection layer of aluminum film or aluminum-related alloy (such as copper aluminum) film is printed on the tin electrodes. Next, heat treatment is performed at 300˜600° C. in air atmosphere. Thus, the aluminum electrodes above protect the tin or tin alloy electrodes below against oxidation, as shown in FIG. 5, in which Diagram (a) shows fine structures observed at 1000× magnification, and Diagram (b) shows energy-dispersive spectroscopy (EDS) images.

Referring to Table 3, thick-film printing aluminum tin-related alloy (such as copper-tin aluminum) film is printed on the block-shaped VDR component to function as outer terminal electrodes and then undergo heat treatment and sintering at 300˜600° C. in air atmosphere, exhibiting excellent electrical characteristics, solderability, and resistance characteristics.

TABLE 3

| | 4C6ASn30% | 4C6ASn40% | 5C5ASn40% |
|---|---|---|---|
| Rdc | 191M | 180M | 177M |
| Rs | 8.6k | 8.7k | 12.3k |
| Cp | 458p | 479p | 470p |
| D | 0.014 | 0.016 | 0.026 |
| surface | 138 m | 186 m | 290 m |
| resistance | | | |
| value | | | |

Referring to Table 4, metal tin film or tin alloy (such as tin copper) film is thick-film printed on a disk-shaped voltage-dependent resistor (VDR), and then metal aluminum film or aluminum-related alloy (such as copper aluminum) film is thick-film printed on the metal tin film or tin alloy (such as tin copper) film to undergo heat treatment and sintering at 300˜600° C. in air atmosphere to acquire electrical characteristics and solderability. The metal tin film or tin alloy film covered with the metal aluminum film maintains its very low resistance value. The voltage-dependent resistor (VDR) of the alloy tin film electrode covered with the metal aluminum film has excellent voltage-dependent resistor characteristics.

TABLE 4

| | 4C6ASn30% | Sn |
|---|---|---|
| Rdc | 191M | 185M |
| Rs | 8.6k | 8.7k |
| Cp | 458p | 466p |
| D | 0.014 | 0.018 |
| surface | 138 m | 66 m |
| resistance | | |
| value | | |

### EMBODIMENT 2

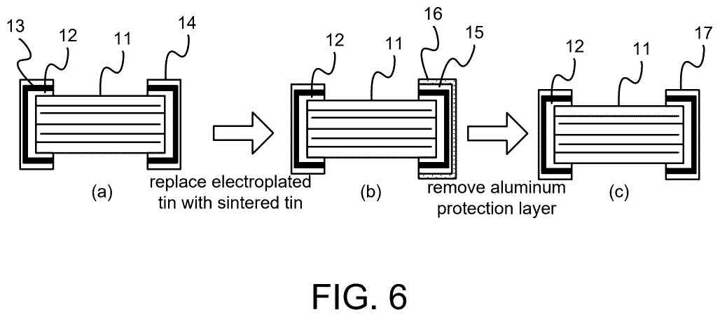

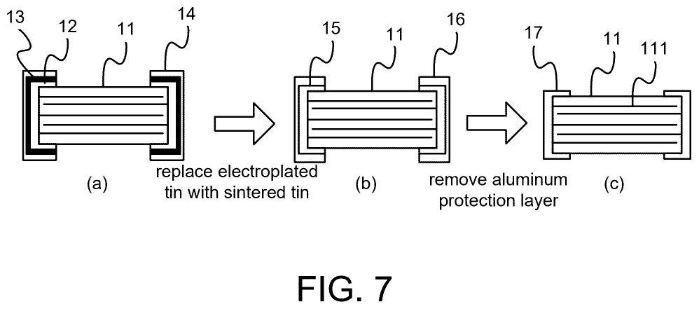

In a preferred specific embodiment of the disclosure, the disclosure provides a novel process applicable to a multilayer ceramic component outer terminal electrode, and the multilayer ceramic component is a low temperature co-fired ceramic (LTCC), multilayer ceramic capacitor (MLCC), multilayer NTC component, or multilayer VDR component.
1. After undergoing high-temperature sintering, multilayer co-fired ceramic component 11 undergoes a silver paste or copper paste dipping process and then undergoes high-temperature sintering in air atmosphere or nitrogen gas atmosphere to form outer terminal electrode 12. Conventionally, electroplated nickel layer 13 and electroplated tin layer 14, as shown in FIGS. 6, 7(a), have to be formed by nickel electroplating and tin electroplating processes in order for a multilayer ceramic component to be soldered to a circuit board. The disclosure entails forming tin layer 15 and aluminum protection layer 16 by tin dipping and aluminum dipping and then performing heat treatment and sintering at 300˜600° C. to remove aluminum protection layer 16 so as to form sintered tin layer outer electrode 17 for replacing conventional electroplated tin layer 14, as shown in FIG. 6(b), (c), so as to dispense with any process that causes pollution to the environment, such as nickel electroplating and tin electroplating.
2. After multilayer co-fired ceramic component 11 has undergone high-temperature sintering, tin layer 15 and aluminum protection layer 16 are formed by tin dipping and aluminum dipping directly and then undergo heat treatment and sintering at 300˜600° C. to remove aluminum protection layer 16 and thus form sintered tin outer electrode 17 for replacing sintered silver or copper outer electrode. Thus, multilayer co-fired ceramic component 11 is not only connected to inner electrode 111 but is also directly soldered to a circuit board without undergoing any tin electroplating process, as shown in FIG. 7(b), (c).

### EMBODIMENT 3

### Chip Resistance

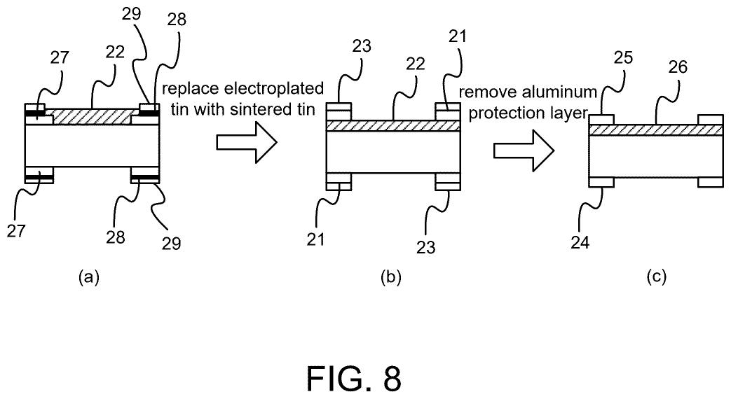

1. The disclosure provides a novel process applicable to a chip resistance electrode, as shown in FIG. 8, in which Diagram (a) depicts a conventional resistance terminal electrode structure, and Diagrams (b), (c) depict a resistance terminal electrode structure of the disclosure.

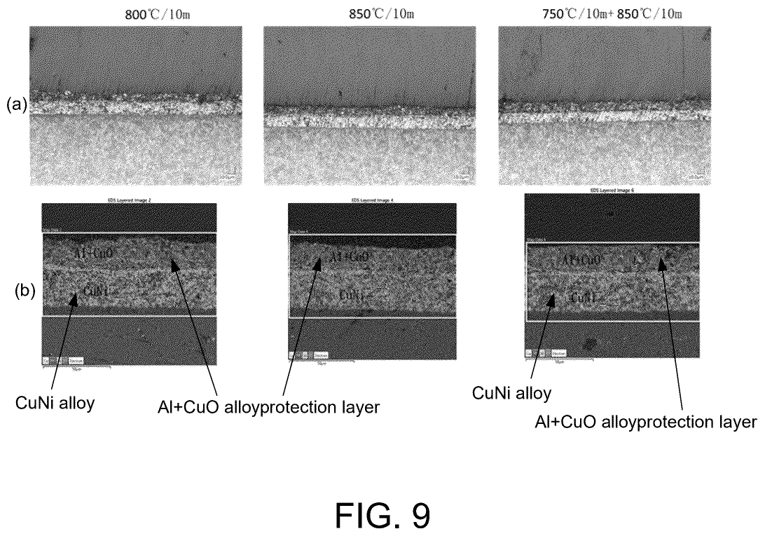

A front electrode and a rear electrode which are connected to a chip resistor and a resistance layer are manufactured by printing tin film 21 connected to resistance film 22, followed by printing aluminum protection layer 23 of aluminum film or aluminum alloy film, and followed by performing heat treatment at 300˜600° C. to form rear tin electrode 24 or front tin electrode 25 sintered in air atmosphere, characterized by high electrical conductivity, and connected to resistance layer 26, as shown in FIG. 8(b), (c), so as to not only ensure that the stability of the characteristics of the resistor equals that of front silver electrode 27 sintered in air atmosphere and characterized by high electrical conductivity, but also allow electroplated nickel layer 28 and electroplated tin layer 29 shown in FIG. 8(a) to be formed without incurring the hassles of performing any electroplating processes.
2. The disclosure provides a novel process applicable to alloy chip resistance, as shown in FIG. 9, in which Diagram (a) shows images of fine structures at different temperatures (800° C./10 min, 850° C./10 min, 750° C./10 min+850° C./10 min), and Diagram (b) shows energy-dispersive spectroscopy (EDS) images processed at different temperatures in Diagram (a).

### (I) Protection Layer

Alloy resistive paste (such as copper nickel, copper manganese, nickel chromium (silicon)) film is printed, and then thick-film aluminum film, aluminum alloy film (such as copper aluminum) or aluminum oxide film is printed on alloy resistive paste film to function as an aluminum protection layer so as to protect the alloy resistive paste film against oxidation during high-temperature heat treatment at 500˜1400° C., maintain high-performance resistance characteristics of the alloy resistive paste film, and allow the aluminum protection layer above to be capable of achieving insulation but exhibiting high thermal conductivity, as shown in FIG. 9.

### (II) Structure

Alloy resistive paste (such as copper nickel, copper manganese, nickel chromium (silicon)) film 32 is printed on substrate 31. Then, thick-film aluminum, aluminum alloy film (such as copper aluminum) or aluminum oxide film is printed on alloy resistive paste film 32 to cover the alloy resistive paste film completely and function as aluminum protection layer 33 so as to protect the alloy resistive paste film against oxidation during high-temperature heat treatment at 500˜1400° C. By performing a chip resistor bending process and a sputtering side-conduction process, high electrical conductivity metals, such as copper or tin, is sputtered to allow copper layer 35 or tin layer to be connected to base metal alloy resistance layer 34 sintered in air atmosphere. As shown in FIG. 10, the chip alloy resistor is sputtered with copper conventionally and then undergoes nickel electroplating and tin electroplating processes to form a component, whereas the chip alloy resistor which is sputtered with tin can form a component without undergoing any nickel electroplating and tin electroplating processes. FIG. 10 is a schematic view of how to sinter an alloy resistor side-conduction electrode in air atmosphere, in which Diagram (a) depicts an etching process, and Diagram (b) depicts an etchless process. The chip resistor sintered in air atmosphere exhibits electrical characteristics shown in Table 5.

TABLE 5

| | | Cu—Ni alloy | Cu—Ni alloy |
|---|---|---|---|
| | Cu—Ni alloy | (70:30) | (70:30) |
| | (70:30) | sintered in air | sintered in air |
| | sintered in | atmosphere, | atmosphere, |
| | nitrogen gas | etching | etching not |
| | atmosphere | required | required |
| resistivity | 36.76*10⁻⁸Ω · m | 46.2*10⁻⁸Ω · m | 42.5*10⁻⁸Ω · m |
| TCR | <100 ppm | 157 ppm | 85 ppm |

Therefore, the essential technical features of the method of the disclosure are as follows:
1. 10˜50 wt % of metallic tin powder and 10˜90 wt % of metallic aluminum powder are added to thick-film printed base metal powder (such as nickel and copper), and then heat treatment is performed thereon at 300˜600° C. in air atmosphere to protect the base metal nickel, copper, and tin against oxidation, increase the melting point of the tin alloy, and obtain the thick-film base metal electrode film that has high solderability and high-performance characteristics.
2. A base metal conductive paste film, such as tin, or a base metal alloy conductive paste film, such as tin alloy (for example, 10˜00 wt % of tin copper), is thick-film printed on a ceramic substrate, and then an aluminum protection layer of a thick-film printed aluminum or aluminum-related alloy (such as copper aluminum) is printed on the base metal conductive paste film or base metal alloy conductive paste film. Then, heat treatment is performed at 300˜600° C. in air atmosphere to prevent the base metal tin and copper from being oxidized and dissolved so as to obtain the thick-film base metal tin electrode film or tin alloy electrode film that has high solderability and high-performance characteristics.
3. The outer electrodes of dielectric ceramic safety capacitors and the outer electrodes of voltage-dependent resistors (VDR) not only require high electrical conductivity but also need to exhibit high solderability. To this end, the ratio of copper and tin content (10˜50 wt %) to aluminum content (10˜90 wt %) is appropriately adjusted to attain solderable electrodes with high electrical conductivity.
4. Semiconductor ceramic NTC/PTC outer terminal electrodes not only need to exhibit high electrical conductivity and high solderability but also need to work with semiconductor ceramic to form an Ohmic contact. To this end, the ratio of copper, nickel, and tin content (10˜50 wt %) to aluminum content (10˜90 wt %) is adjusted such that an Ohmic contact is formed between thick-film electrodes with different work functions to attain solderable electrodes with high electrical conductivity.
5. The outer terminal electrode of a multilayer co-fired ceramic component is manufactured by nickel electroplating, followed by tin dipping or copper-tin dipping, further followed by aluminum dipping for providing protection to tin, further followed by heat treatment (300˜600° C.) in air atmosphere to perform tin or copper-tin sintering, and finally followed by removal of the aluminum protection layer to form a sintered tin or tin copper layer for replacing the electroplated tin layer.
6. The outer terminal electrode of a multilayer co-fired ceramic component is manufactured by tin dipping or copper-tin dipping to replace high-temperature sintered silver electrodes or copper electrodes which currently need to be electroplated with tin, followed by aluminum dipping for providing protection to tin or tin copper, followed by heat treatment (300˜600° C.) in air atmosphere to perform tin or copper-tin sintering, followed by removal of the aluminum protection layer to form a sintered tin or tin copper outer terminal electrode for replacing existing sintered copper or silver, and finally followed by forming the outer terminal electrode by nickel electroplating and tin electroplating.
7. The manufacturing of a chip resistor and a front electrode connected to a resistance layer is achieved by printing tin or copper-tin conductive paste film to be connected to resistance film, followed by printing the aluminum protection layer of aluminum film or aluminum-related alloy (for example, copper aluminum) film to protect the tin or copper-tin conductive paste film against high-temperature oxidation, and followed by performing heat treatment at 500˜1400° C.
8. Alloy resistive paste (such as copper nickel, copper manganese, or nickel chromium (silicon)) film is printed. Then, thick-film aluminum film, aluminum-related alloy [for example, aluminum copper (10˜90 wt %)] film or film of a mixture of aluminum and oxide [for example, aluminum and copper oxide (10˜90 wt %)] is printed on alloy resistive paste film to function as an aluminum protection layer for protecting copper-nickel-manganese alloy resistive paste film against oxidation during heat treatment (500˜1400° C.), maintaining the high-performance resistance characteristics of the alloy resistive paste film, and allowing the aluminum protection layer to be capable of achieving insulation but functioning as a heat dissipating layer with high thermal conductivity upon completion of high-temperature sintering.
9. Referring to the preceding paragraph 8, in order for a chip alloy resistor that can be sintered in air atmosphere to exhibit characteristics of alloy resistance, a metal with high electrical conductivity, for example, copper, is sputtered, and an Ohmic contact is formed inside the alloy resistance layer, for example, copper nickel, while a side-conduction process is underway upon completion of the bending carried out during a chip resistance process, followed by performing subsequent chip resistance-related standard processes.

Comparison of the disclosure and the prior art in terms of distinguishing technical features:
1. According to the prior art, when it comes to base metal heat treatment, thick-film printing conductive copper, nickel, or copper nickel alloy paste film must entail undergoing heat treatment and sintering in reduction atmosphere (nitrogen gas, or a mixture of nitrogen gas and hydrogen gas) to protect the base metal copper, nickel or alloy against oxidation and preclude the resultant loss of its functions, or silver paste is sintered in air atmosphere to function as an outer electrode, exhibiting excellent electrical conductivity, excellent adhesion, and excellent solderability characteristics.

The novel technology proposed by the disclosure involves adding to a base metal tin or tin alloy (such as copper-tin), or covering the base metal tin or tin alloy (such as copper-tin) with, aluminum powder or aluminum film or aluminum-related alloy (such as copper aluminum) film having excellent oxyphilic characteristics and excellent reduction capability to protect the base metal tin or tin alloy (such as copper-tin) against oxidation and preclude the resultant loss of its functions despite high-temperature heat treatment and sintering in air atmosphere.
2. After an existing multilayer ceramic component has been co-fired with an inner electrode, outer terminal electrodes, such as a silver electrode sintered in air atmosphere and a copper electrode sintered in nitrogen gas atmosphere, are manufactured by a dipping process and then subjected to nickel electroplating and tin electroplating processes to protect the terminal electrodes and ensure their excellent solderability characteristics.

The novel technology proposed by the disclosure involves using thick-film aluminum film or aluminum-related alloy (such as copper aluminum) film to protect thick-film tin to manufacture sintered tin electrodes for replacing electroplated tin electrodes to thereby replace an electroplated tin layer for use in manufacturing an outer terminal electrode of a multilayer ceramic component or replacing an outer copper electrode or an initial silver outer terminal electrode of the multilayer ceramic component with a sintered tin outer terminal electrode directly to reduce electroplating processes which might otherwise cause pollution and get in line with environmental, social, and governance (ESG) trends.
3. During the process of manufacturing outer terminal electrodes of plenty of existing ceramic components, sintering an outer terminal electrode of sintered ceramic in reduction atmosphere leads to a change in the characteristics of the sintered ceramic (such as chip resistor, NTC, PTC, VDR, and (piezoelectric) PZT), precluding the use of copper electrodes sintered in nitrogen gas atmosphere.

The novel technology proposed by the disclosure involves using thick-film aluminum film or aluminum-related alloy (such as copper aluminum) film to protect thick-film copper electrode film during heat treatment in air atmosphere, allowing copper electrodes for ceramic components, such as chip resistors, NTC, PTC, VDR, and (piezoelectric) PZT, to be manufactured.
4. Existing chip alloy resistors have extremely low resistance temperature coefficient and are made mainly from a precious metal silver palladium alloy sintered in air atmosphere or from a base metal copper nickel alloy sintered in nitrogen gas atmosphere (nitrogen-hydrogen atmosphere) or reduction atmosphere.

The novel technology proposed by the disclosure involves adding oxide (such as copper oxide) film to thick-film aluminum film or aluminum-related alloy (such as copper aluminum) film or aluminum to function as protective thick-film and allow a base metal alloy (such as copper nickel, copper manganese, nickel chromium) resistor to be sintered in air atmosphere and thus protected against oxidation during a manufacturing process so as to attain the same degree of characteristics as when otherwise sintered in reduction atmosphere (such as copper nickel, copper manganese, nickel chromium).

In conclusion, the disclosure provides a method of sintering solderable base metals in air atmosphere and manufacturing alloy components to effectively overcome the drawbacks of the prior art by manufacturing solderable electrodes through a heat treatment process instead of electroplating processes such that the solderable electrodes dispense with a tin electroplating process but have high solderability and high-performance characteristics. Therefore, the disclosure involves an inventive step and has high industrial applicability, thereby meeting patentability requirements.

The disclosure is disclosed above by preferred embodiments. The embodiments are illustrative of the disclosure but shall not be interpreted as restrictive of the scope of implementation of the disclosure. Hence, all simple equivalent variations and modifications made to the aforesaid embodiments according to the claims and detailed description of the disclosure shall be deemed falling within the scope of the claims of the disclosure.

What is claimed is:

1. A method of sintering solderable base metals in air atmosphere and manufacturing alloy components, comprising the steps of:
introducing 10˜90 wt % of metallic aluminum powder into printed thick-film base metal tin conductive paste film or base metal tin alloy conductive paste film or printing thick-film base metal tin conductive paste film or base metal tin alloy conductive paste film and then printing thereon thick-film aluminum protection layer; and
performing heat treatment at 300˜600° C. in air atmosphere,
wherein high oxyphilic characteristics of the metallic aluminum powder or the aluminum protection layer protect the base metal tin conductive paste film or base metal tin alloy conductive paste film against oxidation during high-temperature sintering in air atmosphere,
wherein, after the base metal tin conductive paste film or base metal tin alloy conductive paste film has undergone high-temperature sintering and oxidation in air atmosphere, the oxidized base metal tin conductive paste film or base metal tin alloy conductive paste film is reduced to metal and alloy because of strong reduction characteristics of the metallic aluminum powder or the aluminum protection layer to obtain a thick-film base metal tin electrode or base metal tin alloy electrode having high solderability and a high melting point.

2. The method of claim 1, wherein the base metal tin alloy conductive paste film is any one of tin copper alloy and tin nickel alloy.

3. The method of claim 1, wherein the aluminum protection layer is any one of aluminum film, aluminum alloy film, and aluminum oxide film.

4. The method of claim 3, wherein the aluminum alloy film is copper aluminum alloy, and the aluminum oxide film is copper oxide.

5. A block-shaped ceramic component, comprising two outer terminal electrodes, disposed on both sides respectively, each being the sintered thick-film base metal tin outer terminal electrode or base metal tin alloy outer terminal electrode formed by the method of claim 1.

6. The block-shaped ceramic component of claim 5, wherein the block-shaped ceramic component is GPS ceramic antenna, negative-temperature-coefficient (NTC) thermistor, positive-temperature-coefficient (PTC) thermistor, voltage-dependent resistor (VDR), or safety capacitor.

7. A multilayer ceramic component, comprising an outer terminal electrode being the sintered thick-film base metal tin outer terminal electrode or base metal tin alloy outer terminal electrode formed by the method of claim 1.

8. The multilayer ceramic component of claim 7, wherein the multilayer ceramic component is low temperature co-fired ceramic (LTCC), multilayer ceramic capacitor (MLCC), multilayer NTC component, or multilayer VDR component.

9. The multilayer ceramic component of claim 7, wherein the multilayer ceramic component undergoes high-temperature sintering, then nickel electroplating, next base metal tin conductive paste film dipping or base metal tin alloy conductive paste film dipping, then aluminum protection layer dipping, and finally heat treatment and sintering in air atmosphere for removal of the aluminum protection layer so as to form the outer terminal electrode.

10. The multilayer ceramic component of claim 7, wherein the multilayer ceramic component undergoes high-temperature sintering, then base metal tin conductive paste film dipping or base metal tin alloy conductive paste film dipping, next aluminum protection layer dipping, and finally heat treatment and sintering in air atmosphere for removal of the aluminum protection layer so as to form the outer terminal electrode.

11. A chip resistor, comprising a front electrode or a rear electrode connected to a resistance layer, the front electrode being the sintered thick-film base metal front tin electrode, base metal front tin alloy electrode, base metal rear tin electrode or base metal rear tin alloy electrode formed by the method of claim 1, and the rear electrode being the sintered thick-film base metal front tin electrode, base metal front tin alloy electrode, base metal rear tin electrode or base metal rear tin alloy electrode formed by the method of claim 1.

12. A method of manufacturing a chip alloy resistor comprising a base metal functioning as an alloy resistance layer, comprising the steps of:
printing thick-film base metal alloy resistive paste film;
printing thereon a thick-film aluminum protection layer; and
performing heat treatment at 500˜1400° C. in air atmosphere by a chip resistance process,
wherein high oxyphilic characteristics of the aluminum protection layer protect the base metal alloy resistive paste film against oxidation during high-temperature sintering in air atmosphere to allow the aluminum protection layer to be capable of achieving insulation but functioning as a heat dissipating layer with high thermal conductivity so as to obtain a thick-film base metal alloy resistance layer having high solderability and resistance characteristics.

13. The method of claim 12, wherein the base metal alloy resistive paste film is any one of copper nickel film, copper manganese film, and nickel chromium (silicon) film.

14. The method of claim 12, wherein the aluminum protection layer is any one of aluminum film, aluminum alloy film, and aluminum oxide film.

15. The method of claim 12, wherein the aluminum alloy film is copper aluminum alloy, and the aluminum oxide film is copper oxide.

16. The method of claim 12, wherein upon completion of folding in the chip resistance process, a side-conduction process is performed to sputter high electrical conductivity metal tin for connection with the base metal alloy resistance layer inside to form an Ohmic contact, and then subsequent standard processes are performed by the chip resistance process to form the chip alloy resistor.
